(19) United States
(12) Patent Application Publication
(10) Pub. No.: US 2023/0161278 A1
(43) Pub. Date: May 25, 2023

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yoshimasa FUJIHARA, Kanagawa (JP); Atsushi SUGAWARA, Kanagawa (JP); Kazutsuna SASAKI, Kanagawa (JP); Takashi INUKAI, Kanagawa (JP)

(73) Assignee: FUJIFILM Business Innovation Corp., Tokyo (JP)

(21) Appl. No.: 17/752,817

(22) Filed: May 24, 2022

(30) Foreign Application Priority Data
Nov. 24, 2021 (JP) 2021-190426

(51) Int. Cl. G03G 9/087; G03G 15/08; G03G 9/08

(52) U.S. Cl. CPC G03G 9/08755; G03G 15/0865; G03G 9/0819

(57) ABSTRACT

An electrostatic charge image developing toner has toner particles that contain a binder resin including a crystalline resin and a release agent and an external additive, in which in a case where d represents a volume-average particle size of the toner particles, the number of domains of the crystalline resin existing in a region from a surface of each of the toner particles to a position at a depth of 0.2d from the surface is 30% by number or more and 90% by number or less with respect to the total number of domains of the crystalline resin.

### CROSS-REFERENCE TO RELATED APPLICATIONS

This application is based on and claims priority under 35 USC 119 from Japanese Patent Application No. 2021-190426 filed Nov. 24, 2021.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

Currently, a method for visualizing image information, such as an electrophotographic method, is used in various fields. In the electrophotographic method, charging and formation of an electrostatic charge image are carried out so that an electrostatic charge image is formed as image information on the surface of an image holder. Furthermore, a toner image is formed on the surface of the image holder by using a developer containing a toner, the toner image is transferred to a recording medium, and then the toner image is fixed on the recording medium. Through these steps, the image information is visualized as an image.

For example, JP2016-184134A discloses an electrostatic charge image developing toner containing a binder resin, a colorant, a release agent, and a plasticizer, in which in a case where Dw represents an average dispersion particle size of domains of the release agent, Nw represents an average number of dispersed domains of the release agent, Dc represents an average dispersion particle size of domains of the plasticizer, and Nc represents an average number of dispersed domains of the plasticizer, all of the following Expressions (1) to (4) are satisfied.

Dw/Dc≥3 (1)

Nc/Nw≥5 (2)

0.3 μm≤Dw≤3.0 μm (3)

0.045 μm≤Dc≤0.9 μm (4)

### SUMMARY

Aspects of non-limiting embodiments of the present disclosure relate to an electrostatic charge image developing toner having toner particles that contain a binder resin including a crystalline resin and a release agent and an external additive, the electrostatic charge image developing toner having better low temperature fixability and a lower detachment rate of the external additive, compared to an electrostatic charge image developing toner in which in a case where d represents a volume-average particle size of toner particles, the number of domains of the crystalline resin existing in a region from a surface of each of the toner particles to a position at a depth of 0.2d from the surface is less than 30% by number or higher than 90% by number with respect to the total number of domains of the crystalline resin.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above problems include the following aspect.

According to an aspect of the present disclosure, there is provided an electrostatic charge image developing toner has toner particles that contain a binder resin including a crystalline resin and a release agent and an external additive, in which in a case where d represents a volume-average particle size of the toner particles, the number of domains of the crystalline resin existing in a region from a surface of each of the toner particles to a position at a depth of 0.2d from the surface is 30% by number or more and 90% by number or less with respect to the total number of domains of the crystalline resin.

### BRIEF DESCRIPTION OF THE DRAWINGS

Exemplary embodiment(s) of the present invention will be described in detail based on the following figures, wherein:

FIG. 1 is a schematic view showing a configuration of an example of an image forming apparatus according to the present disclosure;

FIG. 2 is a schematic view showing a configuration of an example of a process cartridge according to the present disclosure; and

FIG. 3 is a schematic view showing a cross section of a toner particle in an electrostatic charge image developing toner according to the present disclosure.

### DETAILED DESCRIPTION

Hereinafter, an example of one exemplary embodiment of the present invention will be specifically described. The following descriptions and examples merely illustrate the exemplary embodiments, and do not limit the scope of the exemplary embodiments.

Regarding the ranges of numerical values described in stages in the present specification, the upper limit or lower limit of a range of numerical values may be replaced with the upper limit or lower limit of another range of numerical values described in stages.

Furthermore, the upper limit or lower limit described regarding a range of numerical values may be replaced with values described in examples.

In the present specification, in a case where there is a plurality of substances corresponding to each component in a composition, unless otherwise specified, the amount of each component in the composition means the total amount of the plurality of substances existing in the composition.

In the present specification, the term “step” includes not only an independent step but a step which is not clearly distinguished from other steps, as long as the intended goal of the step is achieved.

In the present specification, an electrostatic charge image developing toner is also simply called “toner”, and an electrostatic charge image developer is also simply called “developer”.

Furthermore, in the present specification, in a case where “toner according to the present disclosure” is simply mentioned, unless otherwise specified, “toner according to the present disclosure” refers to both a first exemplary embodiment and a second exemplary embodiment which will be described later.

First Exemplary Embodiment of Electrostatic Charge Image Developing Toner

A first exemplary embodiment of the electrostatic charge image developing toner according to the present disclosure (hereinafter, also called a toner (1) according to the present disclosure or a toner (1)) has toner particles that contain a binder resin including a crystalline resin and a release agent and an external additive, in which in a case where d represents a volume-average particle size of the toner particles, the number of domains of the crystalline resin existing in a region from a surface of each of the toner particles to a position at a depth of 0.2d from the surface is 30% by number or more and 90% by number or less with respect to the total number of domains of the crystalline resin.

In order to achieve low temperature fixability of the toner, a method of incorporating a crystalline resin as a binder resin into the toner particles contained in the toner is adopted. However, in a case where the toner particles contain a release agent together with the crystalline resin, sometimes the low temperature fixability is impaired. Presumably, because both the crystalline resin and the release agent have low polarity, the crystalline resin and the release agent are compatible with each other in the toner particles, which may impair the low temperature fixability that is an effect brought about in a case where the toner particles contain the crystalline resin. Therefore, incorporating a large amount of crystalline resin into the toner particles is also considered, but in this case, the crystalline resin is highly likely to be exposed on the surface of the toner particles. The crystalline resin has low resistance and easily leaks charges. Therefore, in a case where the crystalline resin is exposed on the surface of the toner particles, the electrostatic adhesion between the toner particles and the external additive weakens, and the external additive is easily detached from the toner particles.

The toner particles contained in the toner (1) according to the present disclosure contain a binder resin including a crystalline resin and a release agent, and has a configuration in which in a case where d represents a volume-average particle size of the toner particles, the number of domains of the crystalline resin existing in a region from a surface of each of the toner particles to a position at a depth of 0.2d from the surface (hereinafter, the region will be also called “outer layer portion”) is 30% by number or more and 90% by number or less with respect to the total number of domains of the crystalline resin. Particularly, the configuration in which the number of domains of the crystalline resin existing in the outer layer portion of the toner particles is 30% by number or more and 90% by number or less with respect to the total number of domains of the crystalline resin means that although a sufficient amount of crystalline resin contributing to the low temperature fixability exists in the outer layer portion of the toner particles effective for expressing low temperature fixability, the domains of the crystalline resin are seldom exposed on the surface of the toner particles. Presumably, for this reason, the toner (1) according to the present disclosure having such toner particles and external additive may have a low detachment rate of the external additive. In addition, the toner (1) according to the present disclosure has excellent low temperature fixability.

Hereinafter, the domain of the crystalline resin and the domain of the release agent in each toner particle will be described.

First, the domain of the crystalline resin and the domain of the release agent will be described with reference to a cross section of a toner particle shown in FIG. 3.

FIG. 3 is a schematic view showing a cross section of a toner particle contained in the toner according to the present disclosure. Regarding the reference signs in FIG. 3, TN represents a toner particle, Cry represents a domain of a crystalline resin, Wax represents a domain of a release agent, Amo represents a binder resin, and Tcg represents a geometric center of the toner particle. Furthermore, in a case where d represents a volume-average particle size of the toner particles, a region from the solid line that indicates the surface of the toner particle TN to the dashed line that indicates the position at a depth of 0.2d from the surface corresponds to a region from the surface of the toner particle to a position at a depth of 0.2d from the surface, in other words, the outer layer portion.

Aspect of Toner (1)

In the toner (1) according to the present disclosure, the number of domains of the crystalline resin existing in the outer layer portion is, for example, 30% by number or more and 90% by number or less with respect to the total number of domains of the crystalline resin, preferably 50% by number or more and 88% by number or less with respect to the total number of domains of the crystalline resin, and more preferably 70% by number or more and 86% by number or less with respect to the total number of domains of the crystalline resin.

In the toner (1) according to the present disclosure, from the viewpoint of reducing the detachment rate of the external additive, the number of domains of the crystalline resin existing in a region from the surface of each of the toner particles to a position at a depth of 0.05d from the surface (hereinafter, this region will be also called “surface layer portion”) is, for example, preferably 2% by number or less with respect to the total number of domains of the crystalline resin, and more preferably 1% by number or less with respect to the total number of domains of the crystalline resin. The number of domains of the crystalline resin existing in the surface layer portion is, for example, particularly preferably 0.

As described above, from the viewpoint of reducing the detachment rate of the external additive, in each of the toner particles, for example, it is preferable that the number of domains of the crystalline resin existing in the surface layer portion be small.

Furthermore, in the toner (1) according to the present disclosure, from the viewpoint of low temperature fixability and from the viewpoint of reducing the detachment rate of the external additive, the number of domains of the release agent existing in a portion closer to the inside of each of the toner particles (hereinafter, this portion will be also simply called “inner portion”) than the region from the surface of each of the toner particles to a position at a depth of 0.2d from the surface is, for example, preferably 70% by number or more with respect to the total number of domains of the release agent, more preferably 80% by number or more with respect to the total number of domains of the release agent, and even more preferably 90% by number or more with respect to the total number of domains of the release agent. The number of domains of the release agent existing in the inner portion may be 100% by number with respect to the total number of domains of the release agent. That is, all the domains of the release agent may exist in the aforementioned inner portion.

In the toner (1) according to the present disclosure, from the viewpoint of reducing the detachment rate of the external additive, a domain diameter of the release agent is, for example, preferably 0.5 μm or more and 1.5 μm or less, more preferably 0.6 μm or more and 1.4 μm or less, and even more preferably 0.7 μm or more and 1.3 μm or less.

In a case where the domain diameter of the release agent is 0.5 μm or more, the domain of the crystalline resin is easily attracted to the domain of the release agent existing in the inner portion of each toner particle, and the domain of the crystalline resin is unlikely to be exposed on the surface of the toner particle. As a result, the detachment rate of the external additive can be reduced. Furthermore, in a case where the domain diameter of the release agent is 1.5 μm or less, low temperature fixability may be easily achieved.

In the toner (1) according to the present disclosure, from the viewpoint of reducing the detachment rate of the external additive, the aspect ratio of the domain of the crystalline resin is, for example, preferably 3 or more and 30 or less, and more preferably 5 or more and 20 or less.

In a case where the aspect ratio of the domain of the crystalline resin is 30 or less, the domain of the crystalline resin is unlikely to be exposed on the surface of the toner particles, and the detachment rate of the external additive is easily reduced. Furthermore, in a case where the aspect ratio of the domain of the crystalline resin is 3 or more, low temperature fixability is easily achieved.

In the toner (1) according to the present disclosure, from the viewpoint of reducing the detachment rate of the external additive, a ratio (Y/X) of an aspect ratio Y of the domain of the crystalline resin to an aspect ratio X of the domain of the release agent, for example, preferably satisfies the relationship of 0.2≤Y/X≤30, more preferably satisfies the relationship of 1.5≤Y/X≤25, and even more preferably satisfies the relationship of 3≤Y/X≤22.

In a case where the ratio (Y/X) is 0.2 or more, the variation in the force with which the domain of the release agent in the inner portion of the toner particles attracts the domain of the crystalline resin of the surface layer of the toner particles is suppressed, the domain of the crystalline resin is unlikely to be exposed on the toner surface, and the detachment rate of the external additive is easily reduced. Furthermore, in a case where the ratio (Y/X) is 30 or less, it is easy to achieve low temperature fixability while inhibiting the domain of the crystalline resin from being exposed on the surface of the toner particles.

In the toner (1) according to the present disclosure, from the viewpoint of reducing the detachment rate of the external additive, it is preferable that a domain diameter A of the crystalline resin and a domain diameter B of the release agent satisfy, for example, the relationship of A<B. Furthermore, from the same viewpoint as described above, for example, a ratio (A/B) of the domain diameter A of the crystalline resin to the domain diameter B of the release agent preferably satisfies the relationship of 0.2≤A/B<1, more preferably satisfies the relationship of 0.25≤A/B≤0.95, and even more preferably satisfies the relationship of 0.3≤A/B≤0.9.

In a case where the domain diameter A of the crystalline resin and the domain diameter B of the release agent satisfy the relationship of A<B, the domain of the crystalline resin is unlikely to be exposed on the surface of the toner particles, and the detachment rate of the external additive may be reduced.

The domain diameter of the crystalline resin means the maximum diameter of the domain of the crystalline resin (that is, the maximum length of a straight line connecting any two points on the contour of the domain of the crystalline resin).

In addition, the domain diameter of the release agent means the maximum diameter of the domain of the release agent (that is, the maximum length of a straight line connecting any two points on the contour of the domain of the release agent).

The aspect ratio of the domain of the crystalline resin means a ratio (major axis length/minor axis length) of the major axis length of the domain of the crystalline resin to the minor axis length of the domain of the crystalline resin. The major axis length of the domain of the crystalline resin means the maximum diameter of the domain of the crystalline resin. The minor axis length of the domain of the crystalline resin means the length of the longest line in the domain orthogonal to the line of the maximum diameter.

The aspect ratio of the domain of the release agent means a ratio (major axis length/minor axis length) of the major axis length of the domain of the release agent to the minor axis length of the domain of the release agent. The major axis length of the domain of the release agent means the maximum diameter of the domain of the release agent. The minor axis length of the domain of the release agent means the length of the longest line in the domain orthogonal to the line of the maximum diameter.

“Depth” for the region from the surface of each of the toner particles to a position at a depth of 0.2d or 0.05d from the surface means a distance between the surface of a toner particle and a position below the surface of the toner particle in a direction heading for the center of gravity.

Hereinafter, a method for measuring the domain diameters of the crystalline resin and the release agent, a method for measuring the aspect ratio thereof, and a method for confirming the positions where the domains exist will be described. All of the domain diameters, aspect ratio, and positions where the domains exist are determined by observing the cross section of the toner particles.

The cross section of the toner particles is observed by the following method.

Toner particles (or toner particles to which an external additive is attached) are mixed with and embedded in an epoxy resin, and the epoxy resin is solidified. The obtained solidified substance is cut with an ultramicrotome device (UltracutUCT manufactured by Leica Microsystems), thereby preparing a thin sample having a thickness of 80 nm or more and 130 nm or less. Then, the obtained thin sample is stained with ruthenium tetroxide in a desiccator at 30° C. for 3 hours. Thereafter, by using an ultra-high resolution field emission scanning electron microscope (FE-SEM, S-4800 manufactured by Hitachi High-Tech Corporation.), a STEM observation image (acceleration voltage 30 kV, magnification: 20,000×) of the stained thin sample in a transmission image mode is obtained.

In each of the toner particles, based on contrast and shape, a binder resin (a crystalline resin and an amorphous resin) and a release agent are determined. In the STEM observation image, because the binder resin other than the release agent having more double bond portions compared to the amorphous resin, the release agent, and the like is stained with ruthenium tetroxide, the crystalline resin stained with ruthenium is differentiated into release agent portion and a resin portion other than the release agent. More specifically, the ruthenium staining makes the release agent have the brightest color, the crystalline resin (for example, a crystalline polyester resin) have the second brightest color, and the amorphous resin (for example, an amorphous polyester resin) appear have the darkest color. By contrast adjustment, the release agent appears white, the amorphous resin appears black, and the crystalline resin appears light gray. In this way, the domain of the crystalline resin and the domain of the release agent are differentiated.

In the STEM observation image, 20 toner particles are extracted by image processing software (for example, WinROOF2015, MITANI CORPORATION) and measured as follows.

First, the positions of all the domains of the release agent and the positions of all the domains of the crystalline resin in the toner particles are confirmed.

Then, on the assumption that d represents a volume-average particle size of the toner particles, the number of domains of the crystalline resin existing in a region from the surface of each of the toner particles to a position at a depth of 0.2d from the surface is counted. At this time, the decision of “existing in the region from the surface of each of the toner particles to a position at a depth of 0.2d from the surface” is made based on whether even a part of the domain is included in the region from the surface of each of the toner particles to a position at a depth of 0.2d from the surface. That is, the domain of the crystalline resin that is even partially included in the region from the surface of each of the toner particles to a position at a depth of 0.2d from the surface is determined as “existing in the region from the surface of each of the toner particles to a position at a depth of 0.2d from the surface”.

In the same manner, the number of domains of the crystalline resin existing in a region from the surface of each of the toner particles to a position at a depth of 0.05d from the surface is counted. In this case, the decision of “existing in the region from the surface of each of the toner particles to a position at a depth of 0.05d from the surface” is made in the same manner as described above. The domain of the crystalline resin that is even partially included in the region from the surface of each of the toner particles to a position at a depth of 0.05d from the surface is determined as “existing in the region from the surface of each of the toner particles to a position at a depth of 0.05d from the surface”.

Furthermore, the number of domains of the release agent existing on the inside of the region from the surface of each of the toner particles to a position at a depth of 0.2d from the surface is counted. At this time, the decision of “existing on the inside of the region from the surface of each of the toner particles to a position at a depth of 0.2d from the surface” is made based on whether the entirety of the domain is included on the inside of the region from the surface of each of the toner particles to a position at a depth of 0.2d from the surface. That is, the domain of the release agent that is fully included in the inner portion of the region from the surface of each of the toner particles to a position at a depth of 0.2d from the surface is determined as “existing on the inside of the region from the surface of each of the toner particles to a position at a depth of 0.2d from the surface”.

Twenty toner particles are measured as described above, and the arithmetic mean of the results obtained from the 20 toner particles is adopted.

Furthermore, in the STEM observation image, 20 toner particles are extracted by image processing software (for example, WinROOF2015, MITANI CORPORATION), and for the 20 toner particles, the domain diameter of the crystalline resin, the domain diameter of the release agent, and the aspect ratio thereof are measured, and the arithmetic mean of each of the domain diameter of the crystalline resin, the domain diameter of the release agent, and the aspect ratio obtained from the 20 toner particles is calculated.

The STEM image includes cross sections of toner particles with various sizes. Therefore, the cross sections of toner particles having a cross-sectional diameter of not less than 50% of the volume-average particle size of the toner particles are selected, and adopted as toner particles as observation targets. Herein, the cross-sectional diameter of a toner particle means the diameter of a circle having the same area as the cross section of the toner particle (so-called equivalent circular diameter).

The various average particle sizes of the toner particles including the volume-average particle size d and various particle size distribution indexes of the toner particles are measured using COULTER MULTISIZER II (manufactured by Beckman Coulter Inc.) and using ISOTON-II (manufactured by Beckman Coulter Inc.) as an electrolytic solution.

For measurement, a measurement sample in an amount of 0.5 mg or more and 50 mg or less is added to 2 ml of a 5% aqueous solution of, for example, a surfactant (preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are drawn from small-sized particles. The particle size at which the cumulative proportion of particles is 16% is defined as volume-based particle size D16v and a number-based particle size D16p. The particle size at which the cumulative proportion of particles is 50% is defined as volume-average particle size D50v and a number-average particle size D50p. The particle size at which the cumulative proportion of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The volume-average particle size (d, D50v) of the toner particles is, for example, preferably 2 μm or more and 10 μm or less, and more preferably 4 μm or more and 8 μm or less.

Second Exemplary Embodiment of Electrostatic Charge Image Developing Toner

A second exemplary embodiment of the electrostatic charge image developing toner according to the present disclosure (hereinafter, also called a toner (2) according to the present disclosure or a toner (2)) has toner particles that contain a binder resin including a crystalline resin and a release agent and an external additive, in which domains of the crystalline resins are in the toner particles, and a detachment rate of the external additive with respect to the toner particles is less than 50%.

In the toner (2) according to the present disclosure, as described above, the detachment rate of the external additive with respect to the toner particles is low.

In the toner (2) according to the present disclosure, the detachment rate of the external additive is, for example, preferably 40% or less, and more preferably 30% or less. For example, the lower the detachment rate of the external additive with respect to the toner particles, the more preferable. The lower limit of the detachment rate of the external additive with respect to the toner particles is, for example, 0%, and may be 10%.

For measuring the detachment rate of the external additive with respect to the toner particles, the method for measuring the detachment rate of the external additive in Examples is used.

As for the toner (2) according to the present disclosure, in a case where d represents a volume-average particle size of the toner particles, the number of domains of the crystalline resin existing in a region from a surface of each of the toner particles to a position at a depth of 0.2d from the surface (that is, an outer layer portion) is, for example, preferably 30% by number or more and 90% by number or less with respect to the total number of domains of the crystalline resin.

As for the toner (2) according to the present disclosure, aspects of the number of domains of the crystalline resin existing in the outer layer portion of the toner particles, aspects of the number of domains of the crystalline resin existing in the surface layer portion of the toner particles, and aspects of the number of domains of the release agent existing in the inner portion of the toner particles are the same as the aspects of the items described above regarding the toner (1) according to the present disclosure.

In addition, as for the toner (2) according to the present disclosure, aspects of the domain diameter of the release agent, aspects of the aspect ratio of the domain of the release agent, aspects of the domain diameter of the crystalline resin, aspects of the aspect ratio of the domain of the crystalline resin, aspects of the relationship between the domain diameter of the release agent and the domain diameter of the crystalline resin, and aspects of the relationship between the aspect ratio of the domain of the release agent and the aspect ratio of the domain of the crystalline resin are also the same as the aspects of the items described above regarding the toner (1) according to the present disclosure.

Hereinafter, the toner according to the present disclosure will be specifically described.

The toner according to the present disclosure has toner particles and an external additive.

Toner Particles

The toner particles contain a binder resin and a release agent. The toner particles may contain a colorant and other additives.

Binder Resin

The binder resin contains a crystalline resin. It is preferable that the binder resin include, for example, a crystalline resin and an amorphous resin for dispersing domains of the crystalline resin and domains of the release agent.

A mass ratio (crystalline resin/amorphous resin) of the crystalline resin to the amorphous resin is, for example, preferably 3/97 or more and 50/50 or less, and more preferably 7/93 or more and 30/70 or less.

The amorphous resin means a resin which shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

On the other hand, the crystalline resin means a resin having a clear endothermic peak instead of showing a stepwise change in amount of heat absorbed, in differential scanning calorimetry (DSC).

Specifically, for example, the crystalline resin means a resin which has a half-width of an endothermic peak of 10° C. or less in a case where the resin is measured at a heating rate of 10° C./min, and the amorphous resin means a resin which has a half-width of more than 10° C. or a resin for which a clear endothermic peak is not observed.

The amorphous resin means a resin which shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

On the other hand, the crystalline resin means a resin having a clear endothermic peak instead of showing a stepwise change in amount of heat absorbed, in differential scanning calorimetry (DSC).

Specifically, for example, the crystalline resin means a resin which has a half-width of an endothermic peak of 10° C. or less in a case where the resin is measured at a heating rate of 10° C./min, and the amorphous resin means a resin which has a half-width of more than 10° C. or a resin for which a clear endothermic peak is not observed.

The amorphous resin will be described.

Examples of the amorphous resin include known amorphous resins such as an amorphous polyester resin, an amorphous vinyl resin (for example, a styrene acrylic resin), an epoxy resin, a polycarbonate resin, and a polyurethane resin. Among these, for example, an amorphous polyester resin and an amorphous vinyl resin (particularly, a styrene acrylic resin) are preferable, and an amorphous polyester resin is more preferable.

For example, using an amorphous polyester resin and a styrene acrylic resin in combination as an amorphous resin is also a preferable aspect. Furthermore, for example, using an amorphous resin that has an amorphous polyester resin segment and a styrene acrylic resin segment as an amorphous resin is also a preferable aspect.

Especially, in the event of using an amorphous resin that has an amorphous polyester resin segment and a styrene acrylic resin segment is used as an amorphous resin, in a case where the following resin is bonded to such a resin by an ester bond, the resin is likely to be compatible with an ester-based release agent, and the toner melts better accordingly. Therefore, even though an image is formed on a rough recording medium at a high speed with a high toner application amount, image omission is suppressed.

Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, as the polyhydric alcohol, for example, aromatic diols and alicyclic diols are preferable, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation. In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

Examples of the amorphous polyester resin include an unmodified amorphous polyester resins and a modified amorphous polyester resin. The modified amorphous polyester resin is an amorphous polyester resin containing a bonding group other than an ester bond or an amorphous polyester resin containing resin components different from polyester that are bonded by a covalent bond, an ionic bond, or the like. Examples of the modified amorphous polyester resin include a resin having a modified terminal that is obtained by reacting an active hydrogen compound with an amorphous polyester resin having a terminal into which a functional group such as an isocyanate group is introduced.

The proportion of the amorphous polyester resin in the entire binder resin is, for example, preferably 60% by mass or more and 98% by mass or less, more preferably 65% by mass or more and 95% by mass or less, and even more preferably 70% by mass or more and 90% by mass or less.

Styrene Acrylic Resin

The styrene acrylic resin is a copolymer obtained by copolymerizing at least a styrene-based monomer (monomer having a styrene skeleton) and a (meth)acrylic monomer (monomer having a (meth)acrylic group, for example, preferably a monomer having a (meth)acryloxy group). The styrene acrylic resin includes, for example, a copolymer of a monomer of styrenes and a monomer of (meth)acrylic acid esters.

The acrylic resin portion in the styrene acrylic resin is a partial structure obtained by polymerizing either or both of an acrylic monomer and a methacrylic monomer. Furthermore, “(meth)acryl” is an expression including both of “acryl” and “methacryl”.

Examples of the styrene-based monomer include styrene, α-methylstyrene, metachlorostyrene, parachlorostyrene, parafluorostyrene, paramethoxystyrene, meta-tert-butoxystyrene, para-tert-butoxystyrene, paravinylbenzoic acid, paramethyl-α-methylstyrene, and the like. One kind of styrene-based monomer may be used alone, or two or more kinds of styrene-based monomers may be used in combination.

Examples of the (meth)acrylic monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, 2-hydroxyethyl (meth)acrylate, hydroxypropyl (meth)acrylate, 4-hydroxybutyl (meth)acrylate, and the like. One kind of (meth)acrylic monomer may be used alone, or two or more kinds of (meth)acrylic monomers may be used in combination.

The polymerization ratio between the styrene-based monomer and the (meth)acrylic monomer is, for example, preferably styrene-based monomer:(meth)acrylic monomer=70:30 to 95:5 based on mass.

The styrene acrylic resin may have a crosslinked structure. The styrene acrylic resin having a crosslinked structure can be manufactured, for example, by copolymerizing a styrene-based monomer, a (meth)acrylic monomer, and a crosslinking monomer. The crosslinking monomer is not particularly limited, but is preferably a (meth)acrylate compound having 2 or more functional groups, for example.

The method for preparing the styrene acrylic resin is not particularly limited. For example, solution polymerization, precipitation polymerization, suspension polymerization, bulk polymerization, and emulsion polymerization are used. For the polymerization reaction, a known operation (for example, batch polymerization, semi-continuous polymerization, continuous polymerization, or the like) is used.

The proportion of the styrene acrylic resin in the entire binder resin is, for example, preferably 0% by mass or more and 20% by mass or less, more preferably 1% by mass or more and 15% by mass or less, and even more preferably 2% by mass or more and 10% by mass or less.

The characteristics of the amorphous resin will be described.

The glass transition temperature (Tg) of the amorphous resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K7121-1987, “Testing methods for transition temperatures of plastics”.

The weight-average molecular weight (Mw) of the amorphous resin is, for example, preferably 5,000 or more and 1,000,000 or less, and more preferably 7,000 or more and 500,000 or less.

The number-average molecular weight (Mn) of the amorphous resin is, for example, preferably 2,000 or more and 100,000 or less.

The molecular weight distribution Mw/Mn of the amorphous resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPCHCL-8120GPC manufactured by Tosoh Corporation as a measurement device, TSKgel⋅Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The crystalline resin will be described.

Examples of the crystalline resin include known crystalline resins such as a crystalline polyester resin and a crystalline vinyl resin (for example, a polyalkylene resin, a long-chain alkyl (meth)acrylate resin, and the like). Among these, in view of mechanical strength and low temperature fixability of the toner, for example, a crystalline polyester resin is preferable.

Crystalline Polyester Resin

Examples of the crystalline polyester resin include a polycondensate of a polyvalent carboxylic acid and a polyhydric alcohol. As the crystalline polyester resin, a commercially available product or a synthetic resin may be used.

The crystalline polyester resin easily forms a crystal structure. Therefore, for example, a polycondensate which uses not a polymerizable monomer having an aromatic ring but a linear aliphatic polymerizable monomer is preferable.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like), aromatic dicarboxylic acids (for example, dibasic acids such as phthalic acid, isophthalic acid, terephthalic acid, and naphthalene-2,6-dicarboxylic acid), anhydrides of these, and lower alkyl esters (for example, having 1 or more and 5 or less carbon atoms) of these.

As the polyvalent carboxylic acid, a carboxylic acid having a valency of 3 or more that has a crosslinked structure or a branched structure may be used in combination with a dicarboxylic acid. Examples of trivalent carboxylic acids include aromatic carboxylic acids (for example, 1,2,3-benzenetricarboxylic acid, 1,2,4-benzenetricarboxylic acid, 1,2,4-naphthalenetricarboxylic acid, and the like), anhydrides of these, and lower alkyl esters (for example, having 1 or more and 5 or less carbon atoms) of these.

As the polyvalent carboxylic acid, a dicarboxylic acid having a sulfonic acid group and a dicarboxylic acid having an ethylenic double bond may be used in combination with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like. As the aliphatic diol, among these, for example, 1,8-octanediol, 1,9-nonanediol, and 1,10-decanediol are preferable.

As the polyhydric alcohol, an alcohol having three or more hydroxyl groups and a crosslinked structure or a branched structure may be used in combination with a diol. Examples of the alcohol having three or more hydroxyl groups include glycerin, trimethylolethane, trimethylolpropane, pentaerythritol, and the like.

One kind of polyhydric alcohol may be used alone, or two or more kinds of polyhydric alcohols may be used in combination.

The content of the aliphatic diol in the polyhydric alcohol may be 80 mol % or more and, for example, preferably 90 mol % or more.

The crystalline polyester resin can be obtained by a known manufacturing method, for example, just as the amorphous polyester resin.

As the crystalline polyester resin, for example, a polymer of α,ω-linear aliphatic dicarboxylic acid and α,ω-linear aliphatic diol is preferable.

The polymer of α,ω-linear aliphatic dicarboxylic acid and α,ω-linear aliphatic diol is highly compatible with the amorphous polyester resin. Therefore, even though an image is formed on a rough recording medium at a high speed with a high toner application amount, the toner melts very well during fixing, and the release agent also oozes out very well. As a result, image omission is further suppressed.

As the α,ω-linear aliphatic dicarboxylic acid, for example, an α,ω-linear aliphatic dicarboxylic acid is preferable which has an alkylene group that links two carboxy groups and has a carbon number of 3 or more and 14 or less. The carbon number of the alkylene group is, for example, more preferably 4 or more and 12 or less, and even more preferably 6 or more and 10 or less.

Examples of the α,ω-linear aliphatic dicarboxylic acid include succinic acid, glutaric acid, adipic acid, 1,6-hexanedicarboxylic acid (common name: suberic acid), 1,7-heptanedicarboxylic acid (common name: azelaic acid), 1,8-octanedicarboxylic acid (common name: sebacic acid), 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like. Among these, for example, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferable.

One kind of α,ω-linear aliphatic dicarboxylic acid may be used alone, or two or more kinds of α,ω-linear aliphatic dicarboxylic acids may be used in combination.

As the α,ω-linear aliphatic diol, for example, an α,ω-linear aliphatic diol is preferable which has an alkylene group that links two hydroxy groups and has a carbon number of 3 or more and 14 or less. The carbon number of the alkylene group is, for example, more preferably 4 or more and 12 or less, and even more preferably 6 or more and 10 or less.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, 1,18-octadecanediol, and the like. Among these, 1,6-hexanediol, 1,7-heptanediol, 1,8-octanediol, 1,9-nonanediol, and 1,10-decanediol are preferable.

One kind of α,ω-linear aliphatic diol may be used alone, or two or more kinds of α,ω-linear aliphatic diols may be used in combination.

As the polymer of the α,ω-linear aliphatic dicarboxylic acid and the α,ω-linear aliphatic diol, for example, from the viewpoint of suppressing image omission, a polymer of at least one kind of compound selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one kind of compound selected from the group consisting of 1,6-hexanediol, 1,7-heptanediol, 1,8-octanediol, 1,9-nonanediol, and 1,10-decanediol is preferable. Among these, for example, a polymer of 1,10-decanedicarboxylic acid and 1,6-hexanediol is more preferable.

The proportion of the crystalline polyester resin in the entire binder resin is, for example, preferably 1% by mass or more and 20% by mass or less, more preferably 2% by mass or more and 15% by mass or less, and even more preferably 3% by mass or more and 10% by mass or less.

The characteristics of the crystalline resin will be described.

The melting temperature of the crystalline resin is, for example, preferably 50° C. or higher and 100° C. or lower, more preferably 55° C. or higher and 90° C. or lower, and even more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline resin is, for example, preferably 6,000 or more and 35,000 or less.

The content of the binder resin with respect to the total mass of the toner particles is, for example, preferably 40% by mass or more and 95% by mass or less, more preferably 50% by mass or more and 90% by mass or less, and even more preferably 60% by mass or more and 85% by mass or less.

Release Agent

Examples of the release agent include hydrocarbon-based wax such as paraffin wax; natural wax such as carnauba wax, rice wax, and candelilla wax; synthetic or mineral petroleum-based wax such as montan wax; ester-based wax such as fatty acid esters and montanic acid esters; and the like. The release agent is not limited to these.

The melting temperature of the release agent is, for example, preferably 50° C. or higher and 110° C. or lower, and more preferably 60° C. or higher and 100° C. or lower.

The melting temperature of the release agent is determined from a DSC curve obtained by differential scanning calorimetry (DSC) by “peak melting temperature” described in the method for determining the melting temperature in JIS K7121:1987, “Testing methods for transition temperatures of plastics”.

As the release agent, for example, ester-based wax is preferable. In a case where the ester-based wax is used, the obtained domain of the release agent is likely to be spheric and has a low aspect ratio.

Paraffin wax or Fischer-Tropsch wax may also be used as the release agent. These waxes readily go through crystal growth and make it easier to obtain a domain of a release agent having a high aspect ratio compared to the ester-based wax.

The content of the release agent with respect to the total mass of the toner particles is, for example, preferably 1% by mass or more and 20% by mass or less, and more preferably 5% by mass or more and 15% by mass or less.

Colorant

Examples of colorants include pigments such as carbon black, chrome yellow, Hansa yellow, benzidine yellow, indanthrene yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total mass of the toner particles is, for example, preferably 1% by mass or more and 30% by mass or less, and more preferably 3% by mass or more and 15% by mass or less.

Other Additives

Examples of other additives include well-known additives such as a magnetic material, a charge control agent, and inorganic powder. These additives are incorporated into the toner particles as internal additives.

Characteristics of Toner Particles and the Like

The toner particles may be toner particles that have a single-layer structure or toner particles having a so-called core/shell structure that is configured with a core portion (core particle) and a coating layer (shell layer) covering the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size d (also called D50v) of the toner particles is, for example, preferably 2 μm or more and 15 μm or less, and more preferably 4 μm or more and 8 μm or less.

The average circularity of the toner particles is, for example, preferably 0.94 or more and 1.00 or less, and more preferably 0.95 or more and 0.98 or less.

The average circularity of the toner particles is determined by (circular equivalent perimeter)/(perimeter) [(perimeter of circle having the same projected area as particle image)/(perimeter of projected particle image)].

Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for obtaining the average circularity is 3,500.

In a case where a toner contains external additives, the toner (developer) as a measurement target is dispersed in water containing a surfactant, then the dispersion is treated with ultrasonic waves so that the external additives are removed, and the toner particles are collected.

External Additive

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, an aluminum-based coupling agent, and the like. One kind of each of these agents may be used alone, or two or more kinds of these agents may be used in combination.

Usually, the amount of the hydrophobic agent is, for example, 1 part by mass or more and 10 parts by mass or less with respect to 100 parts by mass of the inorganic particles.

Examples of external additives also include resin particles (resin particles such as polystyrene, polymethylmethacrylate (PMMA), and melamine resins), a cleaning activator (for example, a metal salt of a higher fatty acid represented by zinc stearate or fluorine-based polymer particles), and the like.

The amount of the external additives added to the exterior of the toner particles with respect to the total mass of the toner particles is, for example, preferably 0.01% by mass or more and 5% by mass or less, and more preferably 0.01% by mass or more and 2.0% by mass or less.

Manufacturing Method of Toner

Next, the manufacturing method of the toner according to the present disclosure will be described.

The toner according to the present disclosure is obtained by manufacturing toner particles and then adding external additives to the exterior of the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among these, in view of easily controlling the arrangement of domains of the crystalline resin and the arrangement of domains of the release agent, for example, an aggregation and coalescence method may be used to obtain the toner particles.

Specifically, for example, in a case where the toner particles are manufactured by the aggregation and coalescence method, the toner particles are manufactured through a step of preparing a resin particle dispersion in which resin particles are dispersed and a release agent particle dispersion in which release agent particles are dispersed (particle dispersion preparation step), a step of agglomerating the resin particles and the release agent (plus a colorant and the like as necessary) in a mixed dispersion of the resin particle dispersion and the release agent particle dispersion (or in a mixed dispersion in which a colorant dispersion is also mixed as necessary) so that first aggregated particles are formed (first aggregated particle forming step), a step of obtaining an aggregated particle dispersion in which the first aggregated particles are dispersed, then mixing the aggregated particle dispersion with the resin particle dispersion, and aggregating the resin particles so as to cause the resin particles to further adhere to the surface of the first aggregated particles and to form second aggregated particles (second aggregated particle forming step), a step of obtaining an aggregated particle dispersion in which the second aggregated particles are dispersed, then mixing the aggregated particle dispersion with the resin particle dispersion, and aggregating the resin particles so as to cause the resin particles to adhere to the surface of the second aggregated particles and to form third aggregated particles (third aggregated particle forming step), and a step of heating an aggregated particle dispersion in which the third aggregated particles are dispersed so as to coalesce the third aggregated particles and to form toner particles (coalescence step).

A crystalline resin particle dispersion and an amorphous resin particle dispersion are prepared by the above particle dispersion preparation step among the above steps.

In the first aggregated particle forming step, for example, it is preferable to use the crystalline resin particle dispersion and the amorphous resin particle dispersion.

In the second aggregated particle forming step, for example, it is preferable to use the amorphous resin particle dispersion.

In the third aggregated particle forming step, for example, it is preferable to use the crystalline resin particle dispersion and the amorphous resin particle dispersion.

By using the release agent particle dispersion only in the first aggregated particle forming step among the above steps, it is possible to form first aggregated particles which correspond to the inner portion of the toner particles and contain a large amount of release agent. Thereafter, the domain of the release agent is allowed to grow in the second aggregated particle forming step, and then the third aggregated particle forming step is performed. In the third aggregated particle forming step, by using the crystalline resin particle dispersion in a higher amount than in the first aggregated particle forming step, it is possible to form a coating layer which corresponds to the outer layer portion of the toner particles, is formed in the third aggregated particle forming step, and contains many domains of the crystalline resin. In the third aggregated particle forming step, the coating layer containing in which the domains of the crystalline resin exist is formed on the outside of the second aggregated particles in which the domains of the release agent exist. As described above, the release agent and the crystalline resin are compatible with each other, and there is an action of attraction between the release agent and the crystalline resin. Therefore, in a case where the domains of the release agent are in the second aggregated particles, in the aforementioned coating layer, the domains of the crystalline resin are attracted toward the domains of the release agent. As a result, it is possible to inhibit the domains of the crystalline resin from being exposed on the surface of the toner particles even though the domains are in the coating layer.

By controlling the heating conditions (specifically, the heating temperature and the heating time) of the aggregated particles in the second aggregated particle forming step among the above steps, it is possible to adjust the domain diameter of the release agent. For example, heating the aggregated particles at a high temperature for a long time tends to lead to increase of the domain diameter of the release agent. In contrast, heating the aggregated particles at a low temperature for a short time tends to lead to decrease of the domain diameter of the release agent.

Furthermore, by controlling the cooling conditions (specifically, the cooling rate) at the time of cooling (also called cooling step) the particles that are at a high temperature after going through the coalescence step, it is possible to adjust the aspect ratio of the domains of the crystalline resin in the toner particles. In a case where the cooling rate is low, the crystallization of the crystalline resin is accelerated, and the aspect ratio of the domains of the crystalline resin tends to increase. On the other hand, in a case where the cooling rate is high, the aspect ratio of the domains of the crystalline resin tends to decrease.

Hereinafter, each of the steps will be specifically described.

In the following section, a method for obtaining toner particles containing a colorant and a release agent will be described. The colorant is used as necessary. It goes without saying that other additives different from the colorant may also be used.

Resin Particle Dispersion Preparation Step

First, for example, a colorant particle dispersion in which colorant particles are dispersed and a release agent particle dispersion in which release agent particles are dispersed are prepared together with the resin particle dispersions (the amorphous resin particle dispersion and the crystalline resin particle dispersion) in which the respective resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of these media may be used alone, or two or more kinds of these media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, for example, an anionic surfactant and a cationic surfactant are particularly preferable. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), so that the resin undergoes conversion (so-called phase transition) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of particles, the dispersion medium, the dispersion method, and the particle content in the resin particle dispersion are also applied to the colorant particles to be dispersed in the colorant particle dispersion and the release agent particles to be dispersed in the release agent particle dispersion.

First Aggregated Particle Forming Step

Next, the resin particle dispersions (for example, preferably the crystalline resin particle dispersion and the amorphous resin particle dispersion), the release agent particle dispersion, and the colorant particle dispersion are mixed together.

Then, in the mixed dispersion, the resin particles, and release agent particles, and the colorant particles are hetero-aggregated so that first aggregated particles are formed which have a diameter close to the diameter of the target toner particles and include the resin particles, the release agent particles, and the colorant particles.

Specifically, for example, an aggregating agent is added to the mixed dispersion, the pH of the mixed dispersion is then adjusted so that the dispersion is acidic (for example, pH of 2 or higher and 5 or lower), and a dispersion stabilizer is added thereto as necessary. Thereafter, the dispersion is heated to a temperature equal to or lower than the glass transition temperature of the resin particles (specifically, for example, to a temperature equal to or higher than the glass transition temperature of the resin particles −30° C. and equal to or lower than the glass transition temperature of the resin particles −10° C.) so that the particles dispersed in the mixed dispersion are aggregated, thereby forming the first aggregated particles.

In the first aggregated particle forming step, for example, in a state where the mixed dispersion is being stirred with a rotary shearing homogenizer, an aggregating agent may be added thereto at room temperature (for example, 25° C.), the pH of the mixed dispersion may be adjusted so that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. Particularly, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt as an aggregating agent include metal salts such as calcium chloride, calcium nitrate, barium chloride, magnesium chloride, zinc chloride, aluminum chloride, and aluminum sulfate; inorganic metal salt polymers such as polyaluminum chloride, polyaluminum hydroxide, and calcium polysulfide; and the like.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA), and the like.

The amount of the chelating agent added with respect to 100 parts by mass of amorphous resin particles is, for example, preferably 0.01 parts by mass or more and 5.0 parts by mass or less, and more preferably 0.1 parts by mass or more and less than 3.0 parts by mass.

Second Aggregated Particle Forming Step

Next, an aggregated particle dispersion in which the first aggregated particles are dispersed is obtained, and then the aggregated particle dispersion is mixed with a resin particle dispersion (for example, preferably a crystalline resin particle dispersion). The aggregated particle dispersion may be mixed with a mixed solution of the resin particle dispersion and the release agent particle dispersion.

Then, in the dispersion in which the first aggregated particles and the resin particles are dispersed, the resin particles are aggregated on the surface of the first aggregated particles.

Specifically, for example, in the first aggregated particle forming step, at a point in time when the particle size of the first aggregated particles has reached an intended value, a resin particle dispersion is added to the first aggregated particle dispersion, and the obtained dispersion is heated at a temperature equal to or lower than the glass transition temperature of the resin particles. As necessary, this aggregation operation is repeated once or more times, thereby forming second aggregated particles. At this time, by extending the heating time, it is possible to facilitate the growth of domains of the release agent in the second aggregated particles.

Third Aggregated Particle Forming Step

After the aggregated particle dispersion in which the second aggregated particles are dispersed is obtained, the aggregated particle dispersion and a resin particle dispersion are mixed together.

Then, in the dispersion in which the second aggregated particles and the resin particles are dispersed, the resin particles are aggregated on the surface of the second aggregated particles.

Specifically, for example, in the third aggregated particle forming step, at a point in time when the particle size of the second aggregated particles has reached an intended value, a resin particle dispersion is added to the second aggregated particle dispersion, and the obtained dispersion is heated at a temperature equal to or lower than the glass transition temperature of the resin particles.

Then, the pH of the dispersion is adjusted to stop the progress of aggregation.

Coalescence Step and Cooling Step

The third aggregated particle dispersion in which the third aggregated particles are dispersed is then heated to, for example, a temperature equal to or higher than the glass transition temperature of the resin particles (for example, a temperature higher than the glass transition temperature of the resin particles by 10° C. to 30° C.) so that the aggregated particles coalesce, thereby forming toner particles.

Then, the toner particles formed by heating (that is, the toner particles at a high temperature) are cooled. Herein, in cooling the toner particles formed by heating, in a case where the cooling conditions (specifically, the cooling rate) are controlled as described above, the aspect ratio of the domains of the crystalline resin is controlled.

After the coalescence step, the toner particles formed in a solution undergo known washing step, solid-liquid separation step, and drying step, thereby obtaining dry toner particles.

The washing step is not particularly limited. However, in view of charging properties, for example, displacement washing may be thoroughly performed using deionized water. The solid-liquid separation step is not particularly limited. However, in view of productivity, for example, suction filtration, pressure filtration, or the like may be performed. Furthermore, the method of the drying step is not particularly limited. However, in view of productivity, for example, freeze drying, flush drying, fluidized drying, vibratory fluidized drying, or the like may be performed.

Then, for example, by adding an external additive to the obtained dry toner particles and mixing together the external additive and the toner particles, the toner according to the present disclosure is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

Electrostatic Charge Image Developer

The electrostatic charge image developer according to the present disclosure contains at least the toner according to the present disclosure.

The electrostatic charge image developer according to the present disclosure may be a one-component developer which contains only the toner according to the present disclosure or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; a resin impregnation-type carrier obtained by impregnating porous magnetic powder with a resin; and the like.

Each of the magnetic powder dispersion-type carrier and the resin impregnation-type carrier may be a carrier obtained by coating a core material, which is particles configuring the carrier, with a coating resin.

Examples of the magnetic powder include magnetic metals such as iron, nickel, and cobalt; magnetic oxides such as ferrite and magnetite; and the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, an epoxy resin, and the like.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, which are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and removing solvents; and the like.

The mixing ratio (mass ratio) between the toner and the carrier, represented by toner:carrier, in the two-component developer is, for example, preferably 1:100 to 30:100, and more preferably 3:100 to 20:100.

Image Forming Apparatus/Image Forming Method

The image forming apparatus/image forming method according to the present disclosure will be described.

The image forming apparatus according to the present disclosure includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present disclosure is used.

In the image forming apparatus according to the present disclosure, an image forming method (image forming method according to the present disclosure) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present disclosure, a transfer step of transferring the toner image formed on the surface of the image holder to the surface of a recording medium, and a fixing step of fixing the toner image transferred to the surface of the recording medium.

As the image forming apparatus according to the present disclosure, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In the case of the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present disclosure, for example, a portion including the developing unit may be a cartridge structure (process cartridge) to be attached to and detached from the image forming apparatus. As the process cartridge, for example, a process cartridge is used which includes a developing unit that contains the electrostatic charge image developer according to the present disclosure.

An example of the image forming apparatus according to the present disclosure will be shown below, but the present invention is not limited thereto. Hereinafter, among the parts shown in the drawing, main parts will be described, and others will not be described.

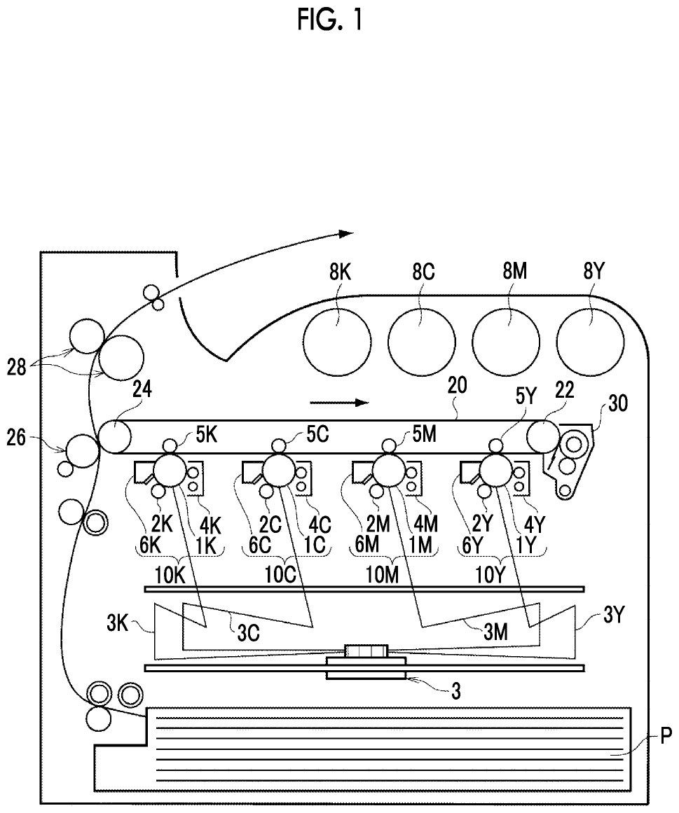

FIG. 1 is a view schematically showing the configuration of the image forming apparatus according to the present disclosure.

The image forming apparatus shown in FIG. 1 includes first to fourth image forming units 10Y, 10M, 10C, and 10K (image forming means) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the surface of the intermediate transfer belt 20 on the image holder side.

Toners including toners of four colors, yellow, magenta, cyan, and black, stored in toner cartridges 8Y, 8M, 8C, and 8K are supplied to developing devices (developing units) 4Y, 4M, 4C, and 4K of units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as these in the first unit 10Y, so that the second to fourth units 10M, 10C, and 10K will not be described again.

The first unit 10Y has a photoreceptor 1Y that acts as an image holder. Around the photoreceptor 1Y, a charging roll 2Y (an example of charging unit) that charges the surface of the photoreceptor 1Y at a predetermined potential, an exposure device 3 (an example of electrostatic charge image forming unit) that exposes the charged surface to a laser beam 3Y based on color-separated image signals so as to form an electrostatic charge image, a developing device 4Y (an example of developing unit) that develops the electrostatic charge image by supplying a charged toner to the electrostatic charge image, a primary transfer roll 5Y (an example of primary transfer unit) that transfers the developed toner image onto the intermediate transfer belt 20, and a photoreceptor cleaning device 6Y (an example of cleaning unit) that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y is rotated to a predetermined development position as the photoreceptor 1Y runs. At the development position, the electrostatic charge image on the photoreceptor 1Y turns in to visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative charge) as the charges with which the surface of the photoreceptor 1Y is charged, and is held on a developer roll (an example of a developer holder). Then, as the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

Meanwhile, the residual toner on the photoreceptor 1Y is removed by a photoreceptor cleaning device 6Y and collected.

Furthermore, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of secondary transfer unit) disposed on the image holding surface side of the intermediate transfer belt 20. Meanwhile, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Then, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth, although the recording paper P is not particularly limited. For instance, coated paper prepared by coating the surface of plain paper with a resin or the like, art paper for printing, and the like are used.

The recording paper P on which the color image has been fixed is transported to an output portion, and a series of color image forming operations is finished.

Process Cartridge/Toner Cartridge

The process cartridge according to the present disclosure will be described.

The process cartridge according to the present disclosure includes a developing unit which contains the electrostatic charge image developer according to the present disclosure and develops an electrostatic charge image formed on the surface of an image holder as a toner image by using the electrostatic charge image developer. The process cartridge is detachable from the image forming apparatus.

The process cartridge according to the present disclosure is not limited to the above configuration. The process cartridge may be configured with a developing device and, for example, at least one member selected from other units, such as an image holder, a charging unit, an electrostatic charge image forming unit, and a transfer unit, as necessary.

An example of the process cartridge according to the present disclosure will be shown below, but the present invention is not limited thereto. Hereinafter, among the parts shown in the drawing, main parts will be described, and others will not be described.

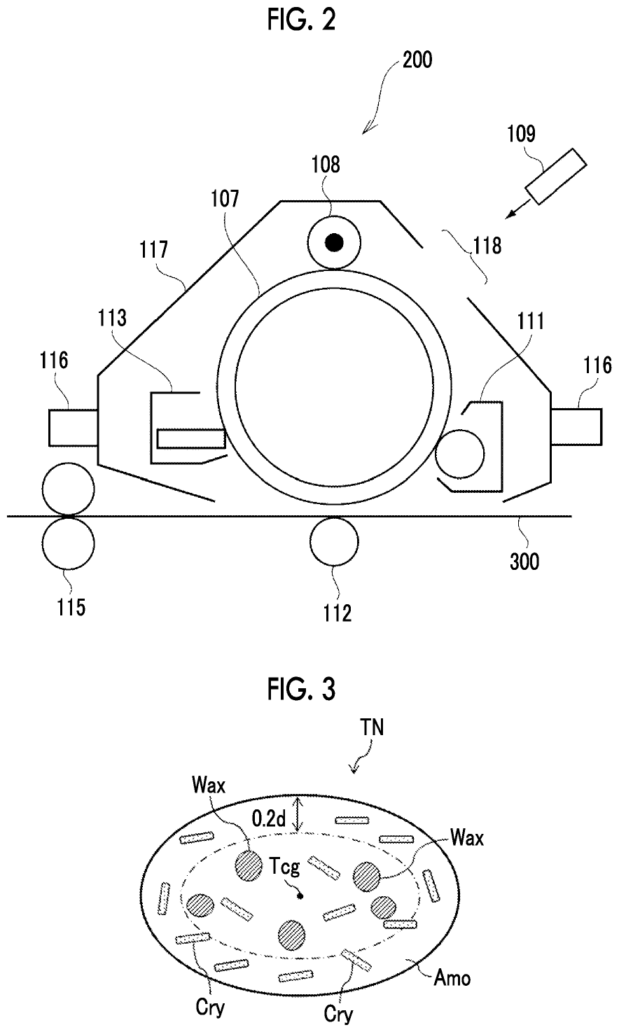

FIG. 2 is a view schematically showing the configuration of the process cartridge according to the present disclosure.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), which are integrally combined and held in the housing 117. The process cartridge 200 forms a cartridge in this way.

In FIG. 2, 109 represents an exposure device (an example of electrostatic charge image forming unit), 112 represents a transfer device (an example of transfer unit), 115 represents a fixing device (an example of fixing unit), and 300 represents recording paper (an example of recording medium).

Next, the toner cartridge according to the present disclosure will be described.

The toner cartridge according to the present disclosure is a toner cartridge including a container that contains the toner according to the present disclosure and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Hereinafter, the present exemplary embodiments will be more specifically described with reference to examples and comparative examples. However, the present exemplary embodiments are not limited to the examples. In addition, unless otherwise specified, “part” and “%” showing amounts are based on mass.

Preparation of Resin Particle Dispersion

Preparation of Amorphous Polyester Resin Particle Dispersion (A1)

Preparation of Amorphous Polyester Resin (A)
Terephthalic acid: 70 parts
Fumaric acid: 30 parts
Ethylene glycol: 41 parts
1,5-Pentanediol: 48 parts

The above materials are put in a flask with an inner capacity of 5 L equipped with a stirrer, a nitrogen introduction tube, a temperature sensor, and a rectifying column, the temperature is raised to 220° C. for an hour under a nitrogen gas stream, and titanium tetraethoxide is added thereto in an amount of 1 part with respect to 100 parts of the above materials. While the generated water is being distilled off, the temperature is raised to 240° C. for 0.5 hours, a dehydrocondensation reaction is continued for 1 hour at 240° C., and then the reactant is cooled. In this way, an amorphous polyester resin (A) having a weight-average molecular weight of 96,000 and a glass transition temperature of 61° C. is synthesized.

Preparation of Amorphous Polyester Resin Particle Dispersion (A1)

Ethyl acetate (40 parts) and 25 parts of 2-butanol are put in a container equipped with a temperature control unit and a nitrogen purge unit, thereby preparing a mixed solvent. Then, 100 parts of the amorphous polyester resin (A) is slowly added to and dissolved in the solvent, a 10% aqueous ammonia solution (in an amount equivalent to 3 times the acid value of the resin in terms of molar ratio) is added thereto, and the mixed solution is stirred for 30 minutes. Thereafter, the container is cleaned out by dry nitrogen purging, and in a state where the mixed solution is being stirred at a temperature kept at 40° C., 400 parts of deionized water is added dropwise thereto at a rate of 2 parts/min so that the mixed solution is emulsified. After dropwise addition ends, the emulsion is returned to 25° C., thereby obtaining a resin particle dispersion in which resin particles having a volume-average particle size of 190 nm are dispersed. Deionized water is added to the resin particle dispersion, and the solid content thereof is adjusted to 20%, thereby obtaining an amorphous polyester resin particle dispersion (A1).

Preparation of Crystalline Polyester Resin Particle Dispersion (B1)

Preparation of Crystalline Polyester Resin (B)
1,10-Decanedicarboxylic acid: 265 parts
1,6-Hexanediol: 168 parts
Dibutyl tin oxide (catalyst): 0.3 parts

The above components are put in a three-necked flask dried by heating, the air in the container is replaced with nitrogen gas by pressure reduction so that an inert atmosphere is created, and the components are mechanically stirred at 180° C. for 5 hours under reflux. Then, the temperature is slowly raised to 230° C. under reduced pressure, and the components are stirred for 2 hours. At a point in time when the components have turned viscous, the reaction system is air-cooled so that the reaction is stopped. The obtained “crystalline polyester resin (B)” has a weight-average molecular weight (Mw) of 12,700 (polystyrene-equivalent molecular weight) obtained by molecular weight determination, and has a melting temperature of 73° C.

Preparation of Crystalline Polyester Resin Particle Dispersion (B1)

The crystalline polyester resin (B) (90 parts by mass), 1.8 parts by mass of an ionic surfactant NEOGEN RK (DKS Co. Ltd.), and 210 parts by mass of deionized water are heated to 120° C., thoroughly dispersed using ULTRA-TURRAX T50 manufactured by IKA, and then subjected to a dispersion treatment using a pressure discharge-type Gorlin homogenizer for 1 hour, thereby obtaining a crystalline polyester resin particle dispersion (B1) having a volume-average particle size of 190 nm and a solid content of 20 parts by mass.

Preparation of Release Agent Particle Dispersion

Preparation of Release Agent Particle Dispersion (W1)

Ester-based wax (70 parts, manufactured by NOF CORPORATION, WEP-5, melting temperature 85° C.), 1 part by mass of an anionic surfactant (manufactured by DKS Co. Ltd., NEOGEN RK), and 200 parts by mass of deionized water are mixed together and dispersed for 10 minutes by using a homogenizer (manufactured by IKA, ULTRA-TURRAX T50). Deionized water is added thereto so that the solid content in the dispersion is 20% by mass, thereby obtaining a release agent particle dispersion (W1). The volume-average particle size of the release agent particles in the release agent particle dispersion is 195 nm.

Preparation of Release Agent Particle Dispersion (W2)

A release agent particle dispersion (W2) is prepared in the same manner as that adopted for preparing the release agent particle dispersion (W1), except that the ester-based wax (manufactured by NOF CORPORATION, WEP-5, melting temperature 85° C.) is changed to paraffin wax (manufactured by NIPPON SEIRO CO., LTD., HNP-0190, melting temperature 89° C.)

Preparation of Release Agent Particle Dispersion (W3)

A release agent particle dispersion (W3) is prepared in the same manner as that adopted for preparing the release agent particle dispersion (W1), except that the ester-based wax (manufactured by NOF CORPORATION, WEP-5, melting temperature 85° C.) is changed to Fischer-Tropsch wax (manufactured by NIPPON SEIRO CO., LTD., FT-105).

Preparation of Colorant Particle Dispersion

Preparation of Colorant Particle Dispersion (C1)
Carbon black (Regal 330, manufactured by Cabot Corporation): 50 parts
Ionic surfactant NEOGEN RK (manufactured by DKS Co. Ltd.): 5 parts
Deionized water: 193 parts

The above components are mixed together and treated with ULTIMAIZER (manufactured by SUGINO MACHINE LIMITED) at 240 MPa for 10 minutes, thereby preparing a colorant particle dispersion (C1) having a solid content concentration of 20%.

### Example 1

Preparation of Toner Particles
Deionized water: 200 parts
Amorphous polyester resin particle dispersion (A1): 180 parts
Crystalline polyester resin particle dispersion (B1): 20 parts
Colorant particle dispersion (C1): 25 parts
Release agent particle dispersion (W1): 35 parts
Anionic surfactant (manufactured by DKS Co. Ltd., NEOGEN RK: 20%): 2.5 parts

The above components are put in a 3L reactor equipped with a thermometer, a pH meter, and a stirrer and continuously stirred for 20 minutes at a rotation speed of 150 rpm. Then, a 0.3N aqueous nitric acid solution is added thereto so that the pH in the system is adjusted to 3.5.

Then, in a state where the components are being dispersed by a homogenizer (manufactured by IKA Japan: ULTRA-TURRAX T50), an aqueous solution of PAC prepared by dissolving 1.2 parts of PAC (manufactured by Oji Paper Co., Ltd.: 30% powder product) in 10 parts of deionized water is added thereto. Thereafter, the obtained mixture is heated to 50° C. while being stirred, the particle size thereof is measured using COULTER MULTISIZER II (aperture size: 50 μm, manufactured by Beckman Coulter Inc.), and the particles are allowed to grow until the volume-average particle size thereof reaches 5.2 μm (the first aggregated particle forming step).

Next, 20 parts of the amorphous polyester resin particle dispersion (A1) is further added thereto and kept as it is for 20 minutes, the pH thereof is then adjusted to 6.5 by using a 1N sodium hydroxide, and then the mixed solution is heated to 75° C. and kept as it is for 60 minutes (the second aggregated particle forming step).

Thereafter, the mixture is cooled to 50° C., a 0.3N aqueous nitric acid solution is added thereto so that the pH in the system is adjusted to 4.5, a mixed solution of 25 parts of the amorphous polyester resin particle dispersion (A1) and 65 parts of the crystalline polyester resin particle dispersion (B1) is further added thereto, and the mixture is kept as it is for 30 minutes.

Subsequently, 15 parts of a 10% aqueous solution of a nitrilotriacetic acid metal salt (CHELEST 70: manufactured by CHELEST CORPORATION) is added thereto, and the pH is adjusted to 9.5 by using a 1N sodium hydroxide (third aggregated particle forming step).

Then, the mixture is heated to 80° C. and kept as it is for 120 minutes so that the particles coalesce, and the particles are cooled to 30° C. at a rate of 2° C./min (the coalescence step and the cooling step).

The obtained toner particles are redispersed in deionized water, filtered repeatedly, washed until the electrical conductivity of the filtrate reaches 20 uS/cm or less, and then vacuum-dried in an oven at 40° C. for 5 hours, thereby obtaining toner particles.

Preparation of Toner

Hydrophobic silica (manufactured by Nippon Aerosil Co., Ltd., RY50) and hydrophobic titanium oxide (manufactured by Nippon Aerosil Co., Ltd., T805) are used in an amount of 1.5 parts and 1.0 parts respectively with respect to 100 parts of the obtained toner particles (1), and these are mixed together for 30 seconds by using a sample mill at 10,000 rpm (revolutions per minute). Then, the toner particles are sieved with a vibrating sieve having an opening size of 45 μm, thereby preparing a toner (1).

The volume-average particle size of the toner particles (1) in the obtained toner (1) is 6.4 μm.

### Examples 2 to 27 and Comparative Examples 1 and 2

Toner particles (2) to (27) are obtained in the same manner as in Example 1, except that the type and amount of the release agent particle dispersion (amount of the dispersion put in the reactor) used in the first aggregated particle forming step, the heating temperature and retention time after the adjustment of pH in the second aggregated particle forming step, and the cooling rate of the particles in the cooling step following the coalescence step, the particles having undergone coalescence by being heated at 80° C. and kept as it is for 120 minutes, are appropriately changed according to Table 1.

Then, by using the obtained toner particles, toners (2) to (27) are obtained in the same manner as in Example 1.

Characteristics

For the toner particles in the toner of each example, the following characteristics are measured according to the method described above.
Proportion of number of domains of crystalline resin existing in region from surface of toner particle to position at depth of 0.2d from the surface [% by number]
Proportion of number of domains of crystalline resin existing in region from surface of toner particle to position at depth of 0.05d from the surface [% by number]
Proportion of number of domains of release agent existing in region closer to inner portion than region from surface of toner particle to position at depth of 0.2d from the surface [% by number]
Domain diameter B of release agent
Domain diameter A of crystalline resin
Aspect ratio X of domain of release agent
Aspect ratio Y of the domain of crystalline resin
Ratio of aspect ratio Y of domain of crystalline resin to aspect ratio X of domain of release agent (Y/X)
Ratio of domain diameter A of crystalline resin to domain diameter B of mold release agent (A/B)

The results are shown in Tables 1 and 2.

Preparation of Electrostatic Charge Image Developer

Each (8 parts by mass) of the obtained toners and 100 parts by mass of a resin-coated ferrite carrier (average particle size 35 μm) are mixed together to prepare a two-component developer, thereby obtaining a developer (electrostatic charge image developer).

The developing unit of DocuPrint C2220 (FUJIFILM Business Innovation Corp.) is filled with each of the obtained developers, and the developer is allowed to go through seasoning for 24 hours in a low-temperature and low-humidity environment (10° C./15% RH).

Evaluation

Low Temperature Fixability

The developing unit of a machine prepared by modifying Apeosport 6-C7771 from FUJIFILM Business Innovation Corp. (modifying the fixing machine so that the fixing temperature is variable) is filled with the developer obtained in each example, the surface temperature of a fixing roll of a fixing unit is changed from 60° C. to 200° C. by 10° C., and images of a solid portion (toner application amount: 4.5 g/m²) and a fine line portion are printed out at each temperature. A crease is made on the inside of approximately central part of the fixed image of the solid portion, and the destruction of the fixed image is visually evaluated. The fixing temperature at which the level of destruction is unproblematic is adopted as a minimum fixing temperature (MFT (° C.)), and low temperature fixability is evaluated based on the following criteria. In this evaluation, the lower the value of MFT (° C.) value, the better the low temperature fixability. The results are shown in Tables 1 and 2.

Evaluation Criteria for Low Temperature Fixability

G1: MFT 110° C.
G2: 110° C.<MFT≤125° C.
G3: 125° C.<MFT≤140° C.
G4: 140° C.<MFT

Transferability

In an environment with a temperature of 28° C. and a humidity of 85%, by using a machine prepared by modifying DocuCentreColor400 (FUJIFILM Business Innovation Corp.), an image sample having a rectangular patch drawn to achieve an image density of 1% is printed out on embossed paper (LESAC 66 manufactured by Tokushu Tokai Paper Co., Ltd., 203 μsm), and then the image quality is evaluated (confirming whether or not color omission occurs). In a case where the obtained image is visually confirmed, the transferability thereof is graded based on the following criteria. In the evaluation, G1 to G3 are regarded as allowable ranges for practical use. The results are shown in Tables 1 and 2.

Evaluation Criteria for Transferability
G1: No color omission occurs in depressions of the embossed paper
G2: Color omission occurs in depressions of the embossed paper, in a region taking up not more than 10% of the image area
G3: Color omission occurs in depressions of the embossed paper, in a region taking up less than 30% of the image area
G4: Color omission occurs in depressions of the embossed paper, in a region taking up not less than 30% of the image area

Detachment Rate of External Additive

Deionized water and octylphenol ethoxylate (aqueous solution of Triton X100 (manufactured by Acros Organics)) are added to a glass bottle, 5 g of toner as an evaluation target is added to the mixed solution, and the mixed solution is stirred 30 times and left to stand for 1 hour or more. Subsequently, the mixed solution is stirred 20 times, and then by using an ultrasonic homogenizer (manufactured by Sonics & Materials, Inc., trade name: homogenizer, model type VCX750, CV33) with a dial set to an output of 30%, ultrasonic energy is applied to the mixed solution for 1 minute under the following conditions. Next, the mixed solution to which ultrasonic energy is applied is suction-filtered using filter paper [trade name: qualitative filter paper (No. 2, 110 mm), manufactured by ADVANTEC TOYO KAISHA, LTD.] and washed again twice with deionized water, the released particles (external additive) are removed by filtration, and then the toner is dried. By fluorescence X-ray spectroscopy, the amount of particles remaining in the toner having undergone the removal of particles by the aforementioned treatment (hereinafter, the amount will be called particle amount after dispersion) and the amount of particles in the toner having not yet been undergone the aforementioned particle removing treatment (hereinafter, the amount will be called particle amount before dispersion) are quantified. The values of particle amount before dispersion and particle amount after dispersion are put in the following Equation 1, and the calculated value is adopted as the detachment rate of particles.

Detachment rate of particles (external additive)(mass %)=[(particle amount before dispersion−particle amount after dispersion)/particle amount before dispersion]×100 Equation 1:

The obtained values of detachment rate of particles are adopted as the detachment rate of the external additive, and shown in Tables 1 and 2.

TABLE 1

| | | | | | | | Domain of crystalline resin | | | |
|---|---|---|---|---|---|---|---|---|---|---|
| | | | | | | | Proportion | Proportion | | |
| | | First aggregated | | | | | of number | of number | | |
| | | particle forming | | | | | of domains | of domains | | |
| | | step | | Second aggregated | | | existing | existing | | |
| | Toner | Type of | | particle forming | | Cooling | in outer | in surface | | |
| | and | release | | step | | step | layer | layer | Domain | |
| | toner | agent | | Heating | Heating | Cooling | portion | portion | diameter | Aspect |
| | particle | particle | Amount | temperature | time | rate | [% by | [% by | A | ratio |
| | No. | dispersion | [parts] | [° C.] | [min] | [° C./min] | number] | number] | [μm] | Y |
| Example 1 | (1) | (W1) | 35 | 75 | 60 | 2.0 | 70 | 0.5 | 0.3 | 19 |
| Example 2 | (2) | (W1) | 35 | 85 | 90 | 2.0 | 32 | 0.3 | 0.4 | 20 |
| Example 3 | (3) | (W1) | 35 | 65 | 60 | 2.0 | 86 | 1.6 | 0.4 | 22 |
| Example 4 | (4) | (W1) | 35 | 65 | 60 | 2.0 | 88 | 2.1 | 0.3 | 18 |
| Example 5 | (5) | (W1) | 25 | 75 | 60 | 2.0 | 75 | 1.5 | 0.6 | 16 |
| Example 6 | (6) | (W1) | 30 | 75 | 60 | 2.0 | 79 | 1.4 | 0.5 | 21 |
| Example 7 | (7) | (W1) | 40 | 75 | 60 | 2.0 | 72 | 0.8 | 0.5 | 19 |
| Example 8 | (8) | (W1) | 35 | 65 | 60 | 2.0 | 84 | 1.2 | 0.2 | 18 |
| Example 9 | (9) | (W1) | 35 | 65 | 60 | 2.0 | 79 | 0.9 | 0.4 | 15 |
| Example 10 | (10) | (W1) | 35 | 90 | 60 | 2.0 | 56 | 0.3 | 0.6 | 17 |
| Example 11 | (11) | (W1) | 35 | 90 | 120 | 2.0 | 41 | 0.2 | 0.5 | 14 |
| Example 12 | (12) | (W1) | 35 | 75 | 60 | 0.5 | 76 | 1.9 | 0.2 | 2.5 |
| Example 13 | (13) | (W1) | 35 | 75 | 60 | 1.1 | 77 | 1.5 | 0.3 | 3.2 |
| Example 14 | (14) | (W1) | 35 | 75 | 60 | 5.1 | 79 | 0.2 | 0.8 | 29 |
| Example 15 | (15) | (W1) | 35 | 75 | 60 | 6.4 | 84 | 0.3 | 0.8 | 32 |

| | Domain of release agent | | | | | | | |
|---|---|---|---|---|---|---|---|---|
| | Proportion | | | | | | | |
| | of number | | | | | | | |
| | of domains | | | | | Evaluation | | |
| | existing | | | | | | | Detachment |
| | in inner | Domain | | | | | | rate of |
| | portion | diameter | Aspect | | | Low | | external |
| | [% by | B | ratio | Ratio | Ratio | temperature | | additive |
| | number] | [μm] | X | (A/B) | (Y/X) | fixability | Transferability | [%] |
| Example 1 | 90 | 0.9 | 6 | 0.3 | 3.2 | G1 | G1 | 24 |
| Example 2 | 82 | 1.3 | 9 | 0.3 | 2.2 | G1 | G2 | 38 |
| Example 3 | 87 | 0.7 | 13 | 0.6 | 1.7 | G2 | G1 | 29 |
| Example 4 | 84 | 0.5 | 14 | 0.6 | 1.3 | G2 | G3 | 51 |
| Example 5 | 68 | 0.9 | 5 | 0.7 | 3.2 | G3 | G3 | 54 |
| Example 6 | 72 | 1.1 | 6 | 0.5 | 3.5 | G2 | G2 | 34 |
| Example 7 | 98 | 1.2 | 8 | 0.4 | 2.4 | G1 | G2 | 21 |
| Example 8 | 84 | 0.4 | 12 | 0.5 | 1.5 | G2 | G2 | 59 |
| Example 9 | 86 | 0.5 | 11 | 0.8 | 1.4 | G2 | G2 | 38 |
| Example 10 | 81 | 1.5 | 2 | 0.4 | 8.5 | G2 | G2 | 21 |
| Example 11 | 83 | 1.8 | 3 | 0.3 | 4.7 | G2 | G2 | 54 |
| Example 12 | 74 | 1.1 | 8 | 0.2 | 0.3 | G3 | G2 | 55 |
| Example 13 | 81 | 1.2 | 6 | 0.3 | 0.5 | G3 | G2 | 29 |
| Example 14 | 76 | 0.9 | 7 | 0.9 | 4.1 | G2 | G3 | 19 |
| Example 15 | 88 | 0.9 | 8 | 0.9 | 4.0 | G2 | G3 | 51 |

TABLE 2

| | | | | | | | Domain of crystalline resin | | | |
|---|---|---|---|---|---|---|---|---|---|---|
| | | | | | | | Proportion | Proportion | | |
| | | First aggregated | | | | | of number | of number | | |
| | | particle forming | | | | | of domains | of domains | | |
| | | step | | Second aggregated | | | existing | existing | | |
| | Toner | Type of | | particle forming | | Cooling | in outer | in surface | | |
| | and | release | | step | | step | layer | layer | Domain | |
| | toner | agent | | Heating | Heating | Cooling | portion | portion | diameter | Aspect |
| | particle | particle | Amount | temperature | time | rate | [% by | [% by | A | ratio |
| | No. | dispersion | [parts] | [° C.] | [min] | [° C./min] | number] | number] | [μm] | Y |
| Example 16 | (16) | (W1) | 35 | 75 | 60 | 0.5 | 83 | 1.8 | 0.3 | 2.1 |
| Example 17 | (17) | (W1) | 35 | 75 | 60 | 0.5 | 78 | 1.7 | 0.3 | 2.3 |
| Example 18 | (18) | (W1) | 35 | 90 | 120 | 5.1 | 81 | 0.3 | 0.7 | 30 |
| Example 19 | (19) | (W1) | 35 | 90 | 120 | 6.4 | 88 | 0.3 | 0.8 | 32 |
| Example 20 | (20) | (W1) | 35 | 70 | 60 | 8.5 | 79 | 0.1 | 0.7 | 14 |
| Example 21 | (21) | (W1) | 35 | 90 | 120 | 1.5 | 81 | 0.9 | 0.2 | 16 |
| Example 22 | (22) | (W1) | 35 | 75 | 120 | 1.5 | 83 | 0.8 | 0.3 | 19 |
| Example 23 | (23) | (W1) | 35 | 70 | 60 | 8.5 | 77 | 0.2 | 0.7 | 18 |
| Example 24 | (24) | (W2) | 35 | 75 | 60 | 2.0 | 81 | 0.9 | 0.6 | 17 |
| Example 25 | (25) | (W3) | 35 | 75 | 60 | 2.0 | 82 | 1.1 | 0.4 | 20 |
| Comparative | (26) | (W1) | 25 | 85 | 90 | 4.0 | 25 | 0.5 | 0.5 | 12 |
| Example 1 | | | | | | | | | | |
| Comparative | (27) | (W1) | 20 | 78 | 60 | 10.0 | 95 | 1.8 | 0.6 | 28 |
| Example 2 | | | | | | | | | | |

| | Domain of release agent | | | | | | | |
|---|---|---|---|---|---|---|---|---|
| | Proportion | | | | | | | |
| | of number | | | | | | | |
| | of domains | | | | | Evaluation | | |
| | existing | | | | | | | Detachment |
| | in inner | Domain | | | | | | rate of |
| | portion | diameter | Aspect | | | Low | | external |
| | [% by | B | ratio | Ratio | Ratio | temperature | | additive |
| | number] | [μm] | X | (A/B) | (Y/X) | fixability | Transferability | [%] |
| Example 16 | 82 | 0.8 | 15 | 0.4 | 0.1 | G3 | G3 | 54 |
| Example 17 | 81 | 0.9 | 14 | 0.3 | 0.2 | G2 | G2 | 39 |
| Example 18 | 85 | 1.1 | 1 | 0.6 | 30.0 | G2 | G2 | 44 |
| Example 19 | 84 | 1.2 | 1 | 0.7 | 32.0 | G3 | G3 | 53 |
| Example 20 | 86 | 0.7 | 8 | 1.0 | 1.8 | G3 | G3 | 59 |
| Example 21 | 91 | 1.8 | 2 | 0.1 | 8.0 | G3 | G3 | 61 |
| Example 22 | 89 | 1.5 | 5 | 0.2 | 3.8 | G2 | G2 | 38 |
| Example 23 | 94 | 0.6 | 8 | 1.2 | 2.3 | G3 | G3 | 62 |
| Example 24 | 91 | 1.4 | 1 | 0.4 | 17.0 | G2 | G2 | 29 |
| Example 25 | 89 | 0.8 | 11 | 0.5 | 1.8 | G2 | G2 | 24 |
| Comparative | 70 | 1.8 | 15 | 0.3 | 0.8 | G4 | G2 | 51 |
| Example 1 | | | | | | | | |
| Comparative | 55 | 1.4 | 2 | 0.4 | 14.0 | G2 | G4 | 71 |
| Example 2 | | | | | | | | |

From the above results, it has been revealed that the present examples have low temperature fixability and a low detachment rate of an external additive. Furthermore, it has been revealed that the present examples also have excellent transferability.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that contain a binder resin including a crystalline resin and a release agent; and
an external additive,
wherein in a case where d represents a volume-average particle size of the toner particles, the number of domains of the crystalline resin existing in a region from a surface of each of the toner particles to a position at a depth of 0.2d from the surface is 30% by number or more and 90% by number or less with respect to the total number of domains of the crystalline resin.

2. The electrostatic charge image developing toner according to claim 1,
wherein the number of domains of the crystalline resin existing in a region from a surface of each of the toner particles to a position at a depth of 0.05d from the surface is 2% by number or less with respect to the total number of domains of the crystalline resin.

3. The electrostatic charge image developing toner according to claim 1,
wherein the number of domains of the release agent existing in a region closer to an inner portion of each of the toner particles than the region from a surface of each of the toner particles to a position at a depth of 0.2d from the surface is 70% by number or more with respect to the total number of domains of the release agent.

4. The electrostatic charge image developing toner according to claim 3,
wherein a domain diameter of the release agent is 0.5 μm or more and 1.5 μm or less.

5. The electrostatic charge image developing toner according to claim 1,
wherein an aspect ratio of the domains of the crystalline resin is 3 or more and 30 or less.

6. The electrostatic charge image developing toner according to claim 1,
wherein a ratio (Y/X) of an aspect ratio Y of the domains of the crystalline resin to an aspect ratio X of domains of the release agent satisfies a relationship of 0.2≤Y/X≤30.

7. The electrostatic charge image developing toner according to claim 1,
wherein a domain diameter A of the crystalline resin and a domain diameter B of the release agent satisfy a relationship of A<B.

8. The electrostatic charge image developing toner according to claim 7,
wherein a ratio (A/B) of the domain diameter A of the crystalline resin to the domain diameter B of the release agent satisfies a relationship of 0.2≤A/B≤1.

9. An electrostatic charge image developing toner comprising:
toner particles that contain a binder resin including a crystalline resin and a release agent; and
an external additive,
wherein domains of the crystalline resin exist in the toner particles, and
a detachment rate of the external additive with respect to the toner particles is less than 50%.

10. An electrostatic charge image developer comprising:
the electrostatic charge image developing toner according to claim 1.

11. A toner cartridge comprising:
a container that contains the electrostatic charge image developing toner according to claim 1,
wherein the toner cartridge is detachable from an image forming apparatus.

12. A process cartridge comprising:
a container that contains the electrostatic charge image developer according to claim 10; and
a developing unit that develops an electrostatic charge image formed on a surface of an image holder as a toner image by using the electrostatic charge image developer,
wherein the process cartridge is detachable from an image forming apparatus.

13. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 10 and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.

14. An image forming method comprising:
charging a surface of an image holder;
forming an electrostatic charge image on the charged surface of the image holder;
developing the electrostatic charge image formed on the surface of the image holder as a toner image by using the electrostatic charge image developer according to claim 10;
transferring the toner image formed on the surface of the image holder to a surface of a recording medium; and
fixing the toner image transferred to the surface of the recording medium.
